(19) United States
(12) Patent Application Publication
(10) Pub. No.: US 2019/0077279 A1
(43) Pub. Date: Mar. 14, 2019

(54) CONTROLLING AN INTERIOR ENVIRONMENT OF A ROAD VEHICLE

(71) Applicant: Jaguar Land Rover Limited, Whitley, Coventry, Warwickshire (GB)

(72) Inventors: Louise MALCOLM, Whitley, Coventry (GB); Paul HERRIOTTS, Whitley, Coventry (GB); Christopher DAVIES, Whitley, Coventry (GB)

(21) Appl. No.: 16/083,442

(22) PCT Filed: Mar. 1, 2017
(86) PCT No.: PCT/EP2017/054756

§ 371 Date: Sep. 7, 2018

(30) Foreign Application Priority Data
Mar. 15, 2016 (GB) 1604400.0

(51) Int. Cl. B60N 2/02; B60R 16/037; B60W 50/08

(52) U.S. Cl. CPC B60N 2/0252; B60W 50/08; B60R 16/0373; B60N 2/0296

(57) ABSTRACT

An apparatus (101) for controlling an interior environment of a road vehicle (120) is disclosed along with a vehicle (120) including the apparatus, a method and a computer program (115). The apparatus comprises controller means (102) configured to control a seat adjustment means (103) for adjusting a configuration of a passenger seat (105) and control at least one parameter defining an interior environment of a road vehicle (120). The controller means (102) is configured to cause the seat adjustment means (103) to adjust the configuration of a passenger seat (105) to a predefined configuration and cause a first one of the parameters to be adjusted to a first predefined value, on receipt of a first signal from a user input means (104) indicating a user selection of a first mode.

### TECHNICAL FIELD

The present disclosure relates to controlling an interior environment of a road vehicle. In particular, but not exclusively, it relates to controlling an interior environment of a car.

Aspects of the invention relate to an apparatus, a vehicle, a method and a computer program.

### BACKGROUND

It is known for cars to have many different electrically powered accessories within their interior, such as reclining seats, calf rests (for supporting the lower leg), window blinds, internal lighting, internal air conditioning or heating, hands-free telephone, etc. These many accessories provide the vehicle with an environment that may be adjusted to suit a person's requirements.

When a passenger travelling in the rear of the car (for example in the second row) wishes to go to sleep, they may attempt to adjust their seat and the environment within the car to make it more conducive to sleep. However, a problem with this is that it can involve making adjustments to numerous environmental parameters, before the person is able to relax and attempt to go to sleep, and also the process of making the many adjustments is not in itself conducive to sleep.

It is an aim of the present invention to address these problems.

### SUMMARY OF THE INVENTION

Aspects and embodiments of the invention provide an apparatus, a vehicle, a method and a computer program as claimed in the appended claims.

According to an aspect of the invention there is provided an apparatus for controlling an interior environment of a road vehicle, the apparatus comprising: controller means configured to control a seat adjustment means for adjusting a configuration of a passenger seat and control at least one parameter defining an interior environment of a road vehicle, wherein the controller means is configured to cause the seat adjustment means to adjust the configuration of a passenger seat to a predefined configuration and cause a first one of the at least one parameters to be adjusted to a first predefined value, on receipt of a first signal from a user input means indicating a user selection of a first mode.

This provides the advantage that it enables a passenger to adjust their seat and their environment within the vehicle with just one user input. When the action of providing the user input is associated with sleep, it also provides the passenger with a cue to sleep, and therefore makes sleep more likely.

The vehicle has a first row comprising a driver's seat and the passenger seat may be located in a second row of the vehicle.

In some embodiments, the controller means is configured to control the seat adjustment means to recline a backrest of the passenger seat to a predefined angle, on receipt of the first signal from the user input means. The controller means may be configured to control the seat adjustment means to provide an angle between the backrest of the seat and a seat cushion of between 125 and 150 degrees, on receipt of the first signal from the user input device, and/or the controller means may be configured to control the seat adjustment means to recline the backrest to an angle of between 40 and 60 degrees from vertical.

This provides the advantage that the passenger does not have to know himself/herself the optimum configuration of the seat for sleeping.

In some embodiments, the controller means is configured to control the seat adjustment means to adjust the tilt of the seat cushion to a predefined angle, on receipt of the first signal from the user input means. The controller means may be configured to control the seat adjustment means to adjust the tilt of the seat cushion to a predefined angle of between 3 and 15 degrees to the horizontal, on receipt of the first signal from the user input device.

This provides the advantage that the passenger does not have to know himself/herself the optimum configuration of the seat cushion for sleeping while remaining in a stable position on the seat.

In some embodiments, the controller means is configured to control the seat adjustment means to raise a calf rest, on receipt of the first signal from the user input means.

In some embodiments, the apparatus comprises a plurality of interior environment modules, each of which is operable to adjust a parameter, and the first one of the at least one parameter comprises the parameter of at least one of the plurality of interior environment modules. The interior environment modules may comprise at least two modules selected from a group consisting of: a window blind module; a climate control module; an interior light module; a communications module; an audio module, an entertainment module.

By arranging for the apparatus to cause the interior environment modules to adjust, the passenger is relieved of the need to cause each adjustment to be made themselves.

In some embodiments, the at least one parameter defines a position of a window blind, and the controller means is configured cause the window blind to be moved to a closed position, on receipt of the first signal from the user input device.

In some embodiments, the at least one parameter comprises an air flow rate, and the controller means is configured to control a climate control means to control a rate of flow of air into the interior of the vehicle to be adjusted to a first predefined value, on receipt of the first signal from the user input device. The first predefined setting may provide a rate of flow of 0.15 m/s (30 ft/min) or below.

By limiting the rate of flow of air, the probability of a passenger obtaining sleep during the journey is increased.

In some embodiments, the at least one parameter comprises a temperature, and the controller means is configured to control a climate control means to raise the temperature of an airflow into the interior of the vehicle to at least a predefined temperature, on receipt of the first signal from the user input device. The predefined temperature may be in the range 19 to 23 degrees centigrade, and may be about 21 degrees centigrade.

By ensuring the air temperature is sufficiently warm, the probability of a passenger obtaining sleep during a journey is increased.

In some embodiments, the at least one parameter defines a setting on a communications module, and the controller means is configured to control the communications module to block or mute incoming phone calls, on receipt of the first signal from the user input device.

In some embodiments, the user input means enables the first mode to be selected in respect of individual passenger seats.

In some embodiments, the at least one parameter defines a setting of an interior light, and the controller means is configured cause the interior light to be dimmed or switched off, on receipt of the first signal from the user input device. The user input means may be configured to enable the first mode to be selected in respect of individual passenger seats; the controller means may be configured to receive an input indicating seat occupancy, and the controller means may be configured to cause lights to be dimmed or turned off for seats where the first mode is selected and to enable lights to be on for occupied seats where the first mode is not selected, on receipt of the first signal from the user input device.

In some embodiments, the user input means is configured to enable the first mode to be selected in respect of individual passenger seats; the controller means is configured to receive an input indicating seat occupancy, and, on receipt of the first signal from the user input device, the controller means is configured to adjust at least one parameter defining an interior environment of the vehicle only in respect of the seat where the first mode is selected.

This provides the advantage that a passenger may be provided with an environment and seat position that provides them with the good probability of obtaining sleep while allowing another passenger to be provided with an environment of their choice.

The vehicle has a first row of seats including a driver's seat and a second row of seats, and in embodiments, the first mode is selectable for seats in the second row and not selectable for seats in the first row.

In some embodiments, the controller means comprises a processor, the seat adjustment means comprises a seat adjustment mechanism including an electric motor arranged to provide movement of a part of a seat, and the user input means comprises an input device configured to generate an electrical signal in response to receiving a physical input.

The user input means may comprise a user operable switch or a soft button on a touch sensitive display.

In some embodiments, the controller is configured to automatically cause the at least one parameter to be adjusted to a different predefined value following a prolonged period of time after causing the at least one parameter to be adjusted to the first predefined value.

This provides the advantage that a sleeping passenger may be gently roused from their sleep after a period of time.

The prolonged period of time may be a user definable period. The prolonged period of time may be ended in dependence upon a user-defined location, and received satellite navigation signals indicating a proximity to the location. This allows the passenger to be roused from their sleep before, or when, they reach their intended destination.

In some embodiments, the controller means is configured to: receive satellite navigation data; to repeatedly determine whether the current location of the vehicle is within a predefined distance of a user-defined location; and to automatically cause the at least one parameter to be adjusted to a different predefined value in dependence upon a determination that the current location of the vehicle is within a predefined distance of the user-defined location.

In some embodiments, the controller means is configured to: receive satellite navigation data; to repeatedly determine an estimated journey time from a current location of the vehicle to a user-defined location, and to automatically cause the at least one parameter to be adjusted to a different predefined value in dependence upon a determination that the estimated journey time is less than a defined period of time. The defined period of time may be a user-defined period of time.

In some embodiments, the controller means is configured to receive a user state signal indicative of a user state, for example, a signal indicative of whether a user is asleep or awake. The user state signal may be provided by an imaging means. The imaging means may be a user-facing camera.

In some embodiments the controller means may be configured to control a seat adjustment means for adjusting a configuration of a passenger seat and control at least one parameter defining an interior environment of a road vehicle in dependence on the user state signal. For example, the controller means may be operable to automatically adjust a configuration of a passenger sear and control the at least one parameter when the user is determined to be asleep. In this way, the apparatus may be operable to account for situations where a user is already asleep.

In embodiments wherein it is determined that the user is asleep, the controller means may be configured to inhibit further adjustment of the configuration of the passenger seat. In this way, the apparatus is operable to account for situations where the user is already asleep, and prevent reconfiguration of the corresponding seat so as not to wake the user.

In embodiments wherein it is determined that the user is asleep, the controller means may be configured to control the at least one parameter defining the interior environment in a different manner to where it is determined that the user is awake. For example, the controller means may be configured to close one or more blinds, windows or other moveable elements of the vehicle at a slower speed where it is determined that the user is asleep. This may prevent abrupt changes in noise and light levels within the vehicle. In this way, the apparatus is operable to account for situations where the user is already asleep, and control the at least one parameter in a way so as not to wake the user.

According to another aspect of the invention there is provided a vehicle comprising an apparatus in accordance with at least one of the apparatus claims.

According to another aspect of the invention there is provided a method of controlling an interior environment of a road vehicle, the method comprising: receiving a first signal indicative of a user input selecting a first mode; and in response to the first signal, controlling a seat adjustment mechanism to adjust the configuration of a passenger seat to a predefined configuration and causing at least one parameter defining an interior environment of a vehicle to be adjusted to a first predefined value.

In some embodiments, the seat adjustment mechanism is controlled to recline a backrest of the passenger seat.

In some embodiments, the at least one parameter defines a position of a window blind, and the method comprises causing the window blind to be moved to a closed position.

In some embodiments, the at least one parameter comprises an air flow rate, and the method comprises causing a rate of flow of air into the interior of the vehicle to be adjusted to a first predefined value.

In some embodiments, the method comprises causing the at least one parameter to be adjusted to a different predefined value following a prolonged period of time after causing the at least one parameter to be adjusted to the first predefined value.

According to a further aspect of the invention there is provided a computer program that, when run on a computer, performs receiving a first signal indicative of a user input selecting a first mode; and in response to the first signal, controlling a seat adjustment mechanism to adjust the configuration of a passenger seat to a predefined configuration and causing at least one parameter defining an interior environment of a vehicle to be adjusted to a first predefined value.

According to a further aspect of the invention there is provided an apparatus for controlling an interior environment of a road vehicle, the apparatus comprising: controller means configured to receive a first signal indicating a user selection of a first mode and to control at least two parameters defining an interior environment of a vehicle, wherein, on receipt of the first signal, the controller means is configured to cause a first one of the parameters to be adjusted to a first predefined value and cause at least a second one of the parameters to be adjusted to a second predefined value.

According to a further aspect of the invention there is provided an apparatus for controlling an interior environment of a road vehicle, the apparatus comprising: a processor configured to control a seat adjustment mechanism for adjusting a configuration of a passenger seat of a vehicle and to control at least one parameter defining an interior environment of the vehicle, wherein the processor is configured to cause the seat adjustment mechanism to adjust the configuration of the passenger seat to a predefined configuration and to cause the at least one parameter to be adjusted to a first predefined value, on receipt of a first electrical signal from a user input device indicating a user selection of a first mode.

According to a further aspect of the invention there is provided an apparatus for controlling an interior environment of a road vehicle, the apparatus comprising: a processor configured to control a seat adjustment mechanism for adjusting a configuration of a passenger seat of a vehicle and to control at least one parameter defining an interior environment of the vehicle; a user input device configured to provide a first electrical signal in response to receiving a physical input from a user selecting a first mode, and wherein the processor is configured to cause the seat adjustment mechanism to adjust the configuration of the passenger seat to a predefined configuration and to cause the at least one parameter to be adjusted to a first predefined value, on receipt of the first electrical signal from the input device.

According to a further aspect of the invention there is provided an apparatus for controlling an interior environment of a road vehicle, the apparatus comprising: controller means configured to control at least one parameter defining an interior environment of a vehicle, wherein the controller means is configured to: cause the at least one parameter to be adjusted to a first predefined value, on receipt of a first signal from the user input means indicating a user selection of a first mode; and automatically cause the at least one parameter to be adjusted to a different predefined value following a prolonged period of time after causing the at least one parameter to be adjusted to the first predefined value.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows schematically an apparatus 101 providing an embodiment of the invention within a vehicle 120;

FIG. 2 shows schematically an apparatus 101 embodying the present invention within a vehicle 120;

FIG. 3 shows a flow chart of a method 300 of controlling an interior environment of a road vehicle;

FIG. 4 shows a flow chart of an example of a process that may be performed at block 303 of FIG. 3;

FIG. 5 shows a flow chart of a method 500 of controlling an interior environment of a road vehicle;

FIG. 6 shows a method 600 of controlling an interior environment of a road vehicle;

FIG. 7 shows a method 700 of controlling an interior environment of a road vehicle; and

FIG. 8 shows an alternative method 800 of controlling an interior environment of a road vehicle.

### DETAILED DESCRIPTION

The Figures illustrate an apparatus 101 for controlling an interior environment of a road vehicle 120, the apparatus comprising: controller means 102 configured to control a seat adjustment means 103 for adjusting a configuration of a passenger seat 105 and control at least one parameter defining an interior environment of a road vehicle 120, wherein the controller means 102 is configured to cause the seat adjustment means 103 to adjust the configuration of a passenger seat 105 to a predefined configuration and cause a first one of the parameters to be adjusted to a first predefined value, on receipt of a first signal from a user input means 104 indicating a user selection of a first mode.

The controller means 102 may comprise a controller (102) comprising one or more processors (106).

The user input means 104 may comprise a user input device configured to receive a mechanical user input and may comprise one or more switches that may be embodied as button switches or soft keys (soft buttons) on a touch screen. The user input device 104 may be labelled or otherwise identified to indicate to the user that when they select the first mode they are selecting a sleep mode, in which their environment will be altered to one that it more conducive to sleep. Consequently, the selection of the first mode itself provides a cue to the passenger that helps them to relax ready for sleep.

As an alternative to a user input device requiring a mechanical input, the user input device may be arranged to receive an alternative user input. For example the user input means may comprise a microphone and speech recognition system suitable for receiving verbal commands and generating the first signal in response to, or in dependence on, receiving a verbal command such as “sleep mode”.

The seat adjustment means (103) may comprise a seat adjustment mechanism (103) of a type that is known in car manufacture. Thus, the seat adjustment mechanism may be suitable for adjusting the angle of a backrest (121) of a seat (105) and/or the angle of the seat cushion (122) and/or the angle of a calf rest (123). The seat adjustment mechanism may be arranged to adjust the configuration of one or more rear seats of the vehicle. That is, it may be arranged to adjust the configuration of a second row of seats (behind the driver's seat) and/or a third row of seats.

Within the present specification the expression “seat cushion” means that part of a seat on which a person usually sits.

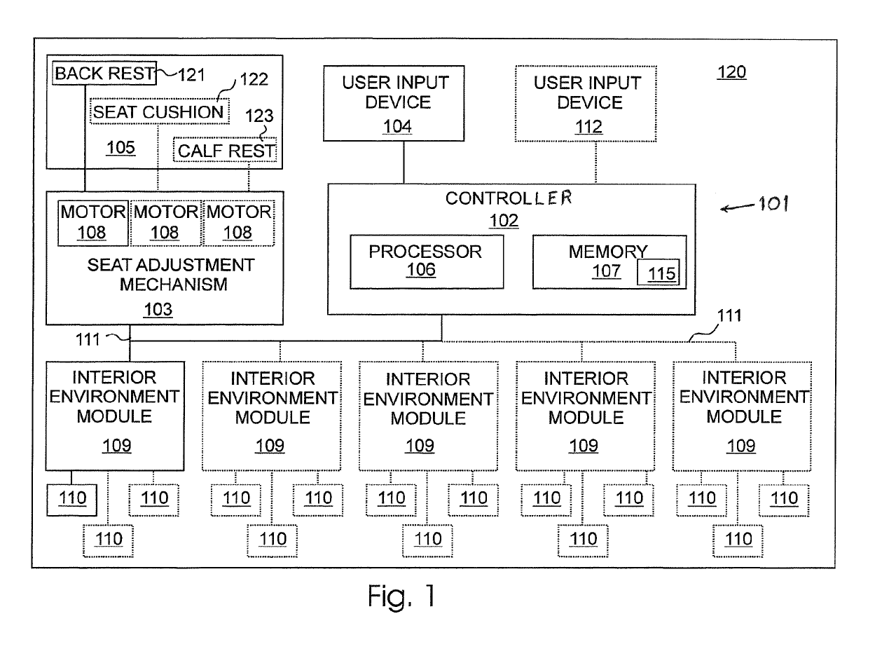

An apparatus 101 providing an embodiment of the invention is shown schematically within a road vehicle in FIG. 1. The apparatus 101 is arranged to control an interior environment of the vehicle 120. The apparatus comprises controller means 102 configured to control a seat adjustment means 103 for adjusting a configuration of a passenger seat 105. The controller means 102 is also configured to control at least one parameter defining an interior environment of the road vehicle.

The apparatus 101 may also comprise user input means 104 for receiving a user input to select a first mode and to provide a first signal to the controller means 102 on receipt of a user input selecting the first mode. On receipt of a first signal from the user input means, the controller means 102 is configured to control the seat adjustment means 103 to adjust the configuration of the passenger seat 105 to a predefined configuration and to cause the at least one parameter to be adjusted to a first predefined value.

The controller means may comprise at least one processor 106 and at least one memory 107. In the present embodiment, the controller means comprises a single processor 106 and a memory 107. The processor 106 in the present embodiment is a general purpose processor but alternatively the controller means may comprise an ASIC (application-specific integrated circuit).

The memory 107 may store a computer program 115 which may be loaded into the processor 106 and run to perform the methods that will be described below. The memory 107 may also be used to store predefined values for the at least one parameter defining an interior environment of the road vehicle and, possibly, user defined settings for the parameters. The memory may also store second different values of at least some of the parameters which may be used in some methods described below.

The seat adjustment means 103 is for adjusting the configuration of at least one passenger seat and may comprise a seat adjustment mechanism of a type that is known in car manufacture. Thus, the seat adjustment mechanism may comprise one or more electric motors 108 for moving one or more components of one or more seats of the vehicle. A first motor 108 may be provided for adjusting the angle of a backrest 121 of a passenger seat 105, a second motor 108 may be provided for adjusting the angle of a seat cushion 122 and a third motor 108 may be provided for adjusting the angle of a calf rest 123.

The apparatus 101 may also comprise one or more interior environment modules 109 configured to provide control of a parameter defining the interior environment of the vehicle. Each interior environment module may be arranged to control one or more elements 110 that is operable for adjusting a parameter that defines the interior environment of the vehicle. (Although three elements 110 are shown for each of the interior environment modules 109, more or less that three elements 110 may be provided for each module.)

For example, the one or more interior environment modules 109 may comprise a window blind module 109 having elements 110 in the form of motor driven window blinds 110 that are operable to close and open window blinds located on rear windows of the vehicle that are adjacent to the rear passenger seats.

In a second example, the one or more interior environment modules 109 may comprise a climate control module 109 that is arranged to control flow rates of air around the interior of the vehicle in the vicinity of the rear seats and temperatures of air blown into the interior in the vicinity of the rear passenger seats 105. Elements 110 of the climate control module may be provided in the form of motors for providing a flow of air towards respective passenger seats, while other elements may comprises heaters and/or air conditioning systems for adjusting air temperatures.

In a third example, the one or more interior environment modules 109 may comprise an interior lights module arranged to control interior lights 110 in the vicinity of the rear passenger seats 105.

In a fourth example, the one or more interior environment modules 109 may comprise an entertainment module arranged to control one or more elements 110, such as a music player, a video player, etc.

In a fifth example, the one or more interior environment modules 109 may comprise a communications module for providing telephone calls to and from the vehicle. The communications module may for a part of an entertainment module.

In the present embodiment the controller 102 is configured to control the seat adjustment mechanism 103 to recline a backrest of a seat, on receipt of a first signal from the user input device, indicating that a user of that seat has selected the first mode. The controller 102 may provide an output signal to the seat adjustment mechanism 103 to control the seat adjustment mechanism to provide an angle between the backrest of the seat and the seat cushion of between 125 and 150 degrees. In some embodiments this angle is between about 130 to 140 degrees and typically 135 degrees. In addition, or as an alternative, the controller controls the seat adjustment means to recline the backrest to an angle of between 40 and 60 degrees from vertical. Typically the backrest is reclined to an angle of about 50 degrees to the vertical.

In an embodiment, the controller 102 is also configured to control the seat adjustment means to adjust the tilt of the seat cushion to a predefined angle, on receipt of the first signal from the user input device 104. Thus for example the seat adjustment means 103 may simultaneously tilt the backrest 121 backwards and tilt the seat cushion 122 in the same direction to provide the passenger with a stable reclined sitting position. During this process, the seat adjustment means 103 may be caused to adjust the tilt of the seat cushion to a predefined angle of between 3 and 15 degrees (and typically about 5 to 10 degrees) to the horizontal with the front of the seat cushion slightly raised compared to the rear of the seat cushion. In two specific embodiments, the seat adjustment means 103 is caused to adjust the tilt of the seat cushion to a predefined angle of about 6 degrees and about 10 degrees respectively.

In an embodiment, on receipt of the first signal from the user input device, the controller is also configured to control the seat adjustment means to adjust the angle of the calf rest to bring the calf rest to a raised position.

In response to, or in dependence on, the receipt of the same first signal from the user input device, the controller 102 is configured to cause at least one parameter defining an interior environment of the vehicle to be adjusted to a first predefined value. The seat adjustment and the adjustment to the at least one parameter may be performed simultaneously or sequentially, but they are performed without any further input being necessary from the user.

In an example, the controller causes the seat to be adjusted and the controller provides an output signal to a window blind module 109 causing the window blind module to close at least a blind nearest to the seat for which the first mode was indicated. The controller may also provide an output signal to a climate control module 109 to cause climate control module 109 to adjust one or more parameters to a predefined value. For example, the at least one parameter may comprise an air flow rate, and the climate control module controls a rate of flow of air into the interior of the vehicle to be adjusted to a first predefined value. For example, the first predefined value provides a rate of flow of 0.15 m/s (30 ft/min) or below.

In addition, or alternatively, the at least one parameter may comprises a temperature and the controller means may be configured to control a climate control module to raise the temperature of an airflow into the interior of the vehicle to at least a predefined temperature, on receipt of the first signal from the user input device. In some embodiments, the predefined temperature is in the range 19 to 23 degrees centigrade, and typically the predefined temperature is about 21 degrees centigrade.

On receipt of the first signal from the user input device, the controller 102 may also be configured to provide an output signal to the interior light module to cause at least one interior light to be dimmed or switched off. In an example, each of the passenger seats have a respective light and only the interior light for the seats for which the first mode is selected is dimmed or switched off. Alternatively all interior lights may be caused to be dimmed or switched off if sleep mode is selected in respect of just one passenger seat.

In addition, a parameter defining the internal environment of the vehicle may define a setting on an entertainment module 109, and the controller 102 may be configured to control the entertainment module to mute the volume, on receipt of the first signal from the user input device.

In addition, a parameter defining the internal environment of the vehicle may define a setting on a communications module 109, and the controller 102 may be configured to control the communications module to block or mute incoming phone calls, on receipt of the first signal from the user input device.

It will be appreciated that one, several or all of the above described interior environment modules 109 may be provided in a vehicle 120, and the controller 102 may be arranged to control one, several or all of the interior environment modules 109 that are provided, in response to, or in dependence on, receiving a first signal indicating that a user has selected the first mode.

The controller 102 may be electrically connected to the seat adjustment mechanism 103 and to each of the one or more interior environment modules 109 by individual wiring. Alternatively, as illustrated in FIG. 1, the controller 102 may provide the predefined values of the parameters to the respective seat adjustment mechanism 103 and each of the one or more interior environment modules 109 by a bus such as a CAN bus (controller area network bus) 111.

In embodiments of the invention, the predefined values of parameters for the interior environment modules 109 and settings for the seat adjustment mechanism 103 when the first mode is selected are not variable by a user of the vehicle. However, in alternative embodiments, one or more of the values/settings may be adjusted by a passenger, for example using the user input device 104 or a second user input device 112. For example, the second user input device may be a touch screen device which may be configured to display the predefined values and enable user inputs to adjust the values. The adjusted values may be temporary for current use of the first mode or may be stored for further uses.

FIG. 1 only shows one user input device and one seat adjustment mechanism. However, it should be understood that the apparatus of FIG. 1 may similarly be used to control two or more seat adjustment mechanisms in response to user inputs at corresponding user input devices.

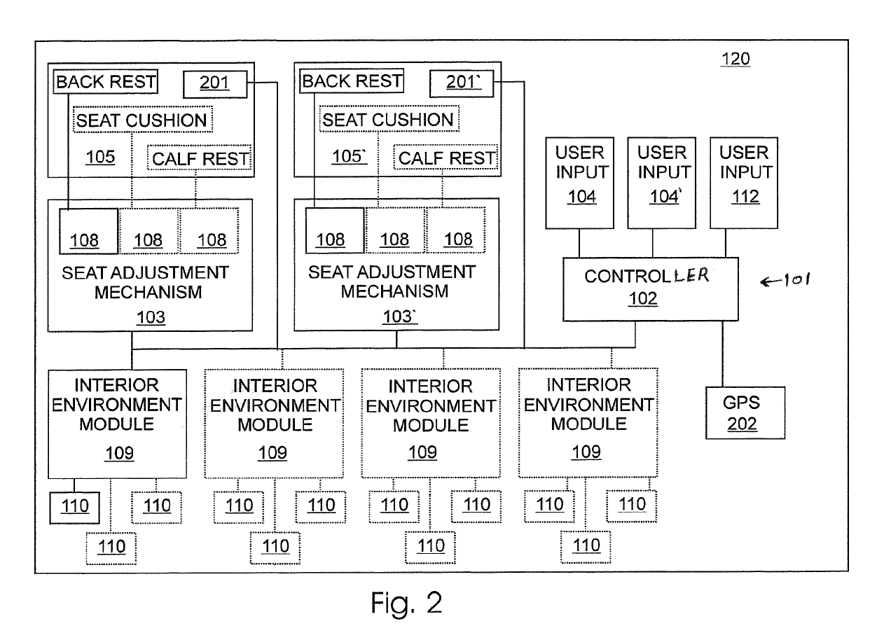

An apparatus 101 embodying the present invention is shown schematically in FIG. 2 within a vehicle 120. Many of the features of FIG. 2 are the same as those described above for FIG. 1 and where they are the same they have been labelled in the same way. These features that are common to FIG. 1 and FIG. 2 will generally not be described again for FIG. 2 except to illustrate where the apparatus of FIG. 2 differs from that of FIG. 1.

The apparatus 101 of FIG. 2 has a first user input means 104 for receiving a user input indicating that a passenger in a first rear seat of the vehicle 120 requires the first mode, and a second user input means 104′ for receiving a user input indicating that a passenger in a second rear seat of the vehicle 120 requires the first mode. The first and second user input means 104 and 104′ may be provided as two individual input devices, such as two individual hard buttons or two individual soft keys each provided on an individual touch screen device. Alternatively, the first and second user input means 104 and 104′ may be provided as separate soft keys on the same touch screen device.

The apparatus 101 of FIG. 2 also comprises two seat sensors 210 and 201′ which are arranged to detect the presence of a person in each of two seats 105 and 105′. In this arrangement, the user input means enables the first mode to be selected in respect of individual passenger seats by selection of the first mode using the user input means 104 and 104′. The controller 102 is configured to receive an input from each of the seat sensors 201 and 201′ indicating seat occupancy, and, on receipt of the first signal from a user input device 104 or 104′, the controller may be configured to provide signals to at least one of the interior environment modules that are dependent upon whether one or both of the seats 105, 105′ are occupied.

In an example, where only one seat 105, 105′ is occupied and a passenger selects the first mode, the controller 102 may cause a window blind module 109 to close window blinds on both sides of the vehicle 120. However, when both seats 105 and 105′ are occupied and only one passenger selects the first mode, the controller may cause the window blind module to close a blind on the side window closest to the seat where the first mode has been selected but not close the blind on the opposite side window.

Similarly, in an example, where only one seat 105, 105′ is occupied and a passenger selects the first mode, the controller may cause all lights in the vehicle, or in the rear of the vehicle, to be dimmed or turned off by the interior light module 109. However, when both seats 105 and 105′ are occupied and only one passenger selects the first mode, the controller may cause the lights to be dimmed or turned off for the seat where the first mode is selected and enable lights to be on for the occupied seat where the first mode is not selected.

It is an aim of the apparatus 101 to provide an environment for a passenger that is conducive to sleep. This is done by adjusting the parameter(s) that define an interior environment of the vehicle to predefined value(s). In some embodiments, the controller is configured to automatically cause at least one of the parameter(s) to be adjusted to a different predefined value following a prolonged period of time after causing the parameter(s) to be adjusted to the first predefined value(s). For example, following selection of the first mode, the controller may cause the seat to be reclined, the temperature of air provided by the climate control module to be increased to a predefined value, the blinds to the sides of the rear passenger seats to be closed and the lights to be turned off in the rear of the vehicle. After a prolonged period of time, the controller may cause the temperature to be slightly reduced and/or the lights to be turned on to encourage a sleeping passenger to awaken. After waking, the woken passenger may manually control the seat adjustment mechanism and the window blinds as required.

The prolonged period of time may be a period of time that is user definable by providing user inputs via the user input means 104 or 104′ or an additional user input device (such as user input device 112). Typically the prolonged period is longer than about 15 minutes so that the passenger has sufficient time to have a short sleep.

The apparatus 101 of FIG. 2 also comprises a global navigation satellite system (GNSS) module, in the form of a GPS module 202, configured to receive satellite transmitted signals and to provide data to the controller 102 indicating the current location of the vehicle 120. In such an embodiment, instead of selecting the prolonged period a user may instead select a geographical location, for example, at or close to the intended destination. The controller may then repeatedly (or continuously) determine the current location of the vehicle from data provided by the GPS module and compare it to the location selected by the user. The prolonged period of time may then be ended in dependence upon received satellite navigation signals from the GPS module indicating a proximity to the selected location.

As a further alternative, the user may select a geographical location, for example, at or close to the intended destination and also select a period of time. In such an embodiment the controller 102 may repeatedly determine the current location of the vehicle from data provided by the GPS module and estimate the time for travelling from the current location to the user-selected location. When the estimated time for travelling is less than the selected period of time, the prolonged period of time may then be ended, that is the controller may then cause the parameter(s) (such as temperature, air flow rate and lighting level) to be adjusted to a different predefined value.

As a further alternative, the controller means 102 may be configured to receive a user state signal indicative of a user state, for example, a signal indicative of whether a user is asleep or awake. The user state signal may be provided by an imaging means, such as a user-facing camera (not shown). The controller means 102 may be configured to automatically control the seat adjustment means 103 for adjusting a configuration of the passenger seat 105, and at least one parameter defining an interior environment of the road vehicle, in dependence on the user state signal. For example, where it is determined (from the user state signal) that the user is asleep, the controller means 102 may be configured to inhibit further adjustment of the configuration of the passenger seat 105. Further, wherein it is determined that the user is asleep, the controller means 102 may be configured to control the at least one parameter defining the interior environment in a different manner to where it is determined that the user is awake. For example, the controller means 102 may be configured to close one or more blinds 110, or other moveable elements of the vehicle at a slower speed where it is determined that the user is asleep.

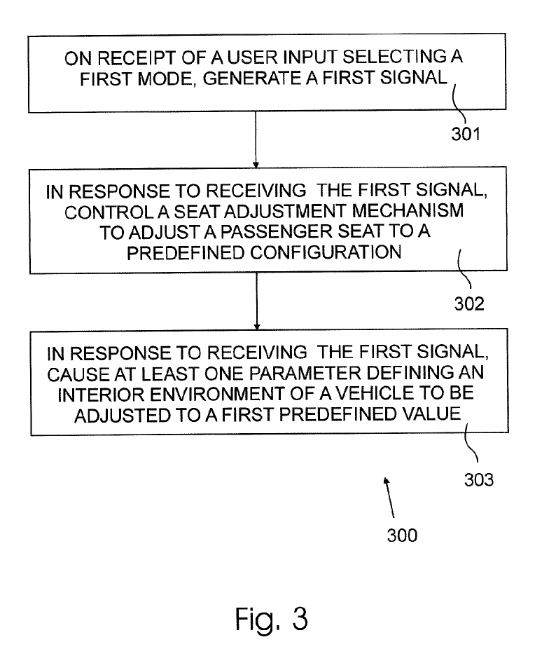

A method 300 of controlling an interior environment of a road vehicle is shown in the flow chart of FIG. 3. The method comprises at block 301, generating a first signal on receipt of a user input selecting a first mode. Typically the first mode will be known to the driver as a mode for providing an environment in the vehicle that facilitates sleep. Consequently, the user experience of selecting the first mode will act as a cue for them to go to sleep.

The process at block 301 may be performed by a user input device such as device 104 of FIG. 1 or FIG. 2.

In response to, or independence on, receiving the first signal, a seat adjustment mechanism is controlled at block 302 to adjust the configuration of a passenger seat to a predefined configuration. For example, the seat adjustment mechanism is controlled to recline a backrest of the passenger seat to a predefined angle.

In addition, in response to, or in dependence on, receiving the first signal, at least one parameter defining an interior environment of a vehicle is caused to be adjusted to a first predefined value at block 303. For example, the at least one parameter may define a position of a window blind, and the method comprises causing the window blind to be moved to a closed position and/or the at least one parameter comprises an air flow rate, and the method comprises causing a rate of flow of air into the interior of the vehicle to be adjusted to a first predefined value.

The processes at block 302 and 303 may be performed by the controller 102 of FIG. 1 or FIG. 2.

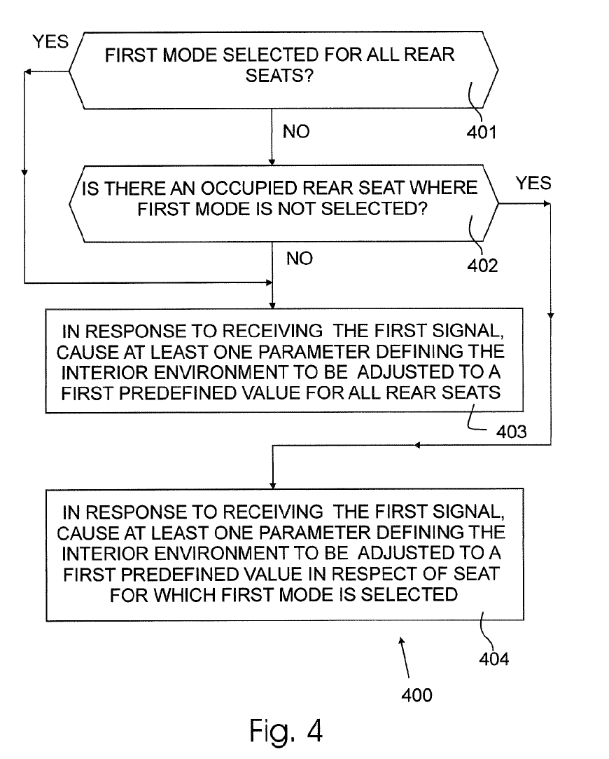

An example of a process that may be performed at block 303 is shown in the flow chart of FIG. 4. It will be appreciated that the process in FIG. 4 follows the generation of a first signal at block 301, indicating that a user of a seat has selected the first mode.

At block 401 it is determined whether the first mode has been selected for all rear seats of the vehicle. If it has, then the process at block 403 is performed, in which at least one parameter defining an interior environment of the vehicle is adjusted in respect of all rear seats. For example, the window blinds adjacent to the rear passenger seats may all be closed and all interior lights in the rear of the vehicle (at least) may be dimmed or turned off.

If it is determined at block 401 that the first mode has not been selected for all rear seats of the vehicle, then the process at block 402 is performed, in which it is determined if there is an occupied rear seat where first mode has not been selected. If there is not then the above described process at block 403 may be performed. Alternatively, if there is an occupied rear seat where first mode is not selected then the process at block 404 is performed, in which at least one parameter defining an interior environment of the vehicle is adjusted only in respect of the seat where the first mode is selected. Therefore, for example, the window blind adjacent to the seat for which first mode has been selected may be closed while other blinds may be left open (if they are open). Similarly only interior lights in the vicinity of that seat may be dimmed or turned off, while other interior lights are not dimmed or turned off (if they are on).

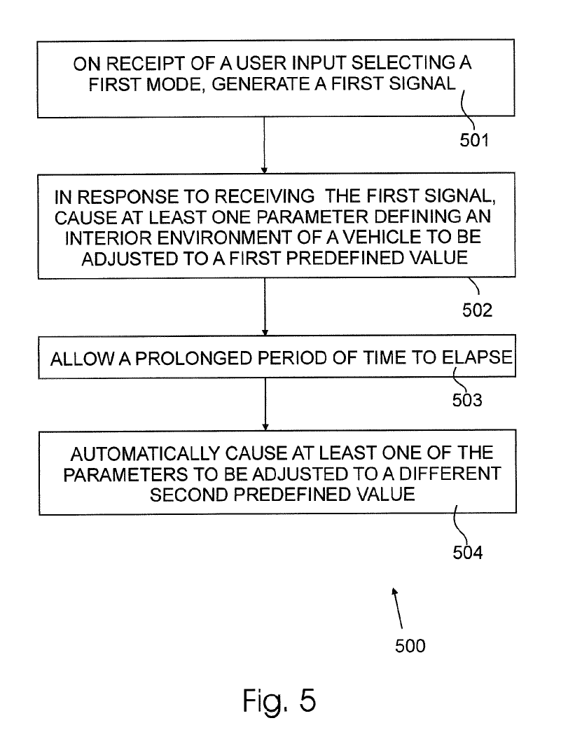

An alternative method 500 of controlling an interior environment of a road vehicle is shown in the flow chart of FIG. 5. The method comprises at block 501, generating a first signal on receipt of a user input selecting a first mode.

The process at block 501 may be performed by a user input device such as device 104 of FIG. 1 or FIG. 2.

In response to, or in dependence on, receiving the first signal, at least one parameter defining an interior environment of a vehicle is caused to be adjusted to a first predefined value at block 502. The process at block 502 may be performed by the controller 102 of FIG. 1 or FIG. 2.

At block 503 a prolonged period of time is allowed to elapse. The prolonged period of time will generally be sufficiently long for a person to go to sleep and sleep for a short period of time. The prolonged period will typically be longer than 15 minutes and may be selected directly by a user or may dependent upon other selections by a user, such as dependent upon a geographical location selected by a user.

After the prolonged period has elapsed at block 503, at least one of the at least one parameters is automatically caused to be adjusted to a second predefined value at block 504. Thus, for example, as described above, if air temperature provided by a climate control module is set to a particular value at block 502, the air temperature is set to a different lower value at block 504 to encourage a sleeping person to awaken.

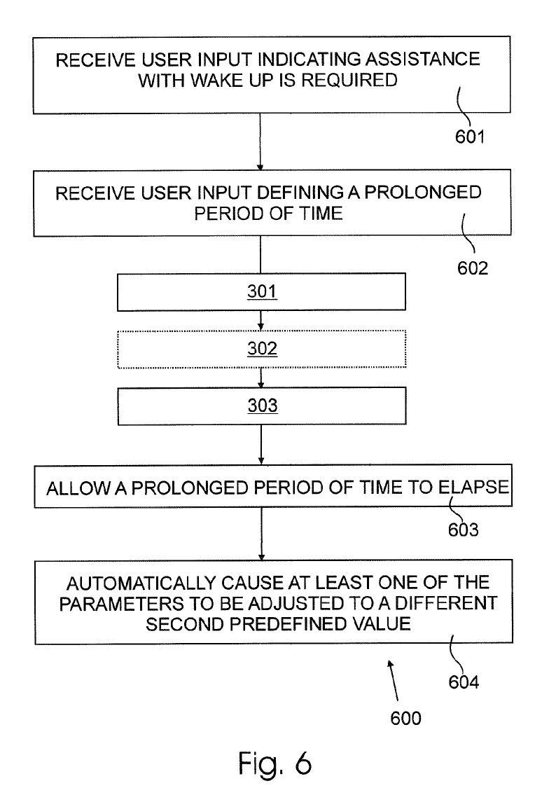

Another method 600 of controlling an interior environment of a road vehicle is shown in the flow chart of FIG. 6. At block 601 a user input signal is received indicating that assistance with waking up is required. Optionally at block 602 a user input may be received defining a prolonged period of time. The method 600 comprises the blocks 301, 303 and optionally block 302 which may be the same as those blocks in method 300. After block 303, a prolonged period of time, which may have been defined at block 602 is allowed to elapse. After the prolonged period has elapsed at block 603, at least one of the at least one parameters is automatically caused to be adjusted to a second predefined value at block 604.

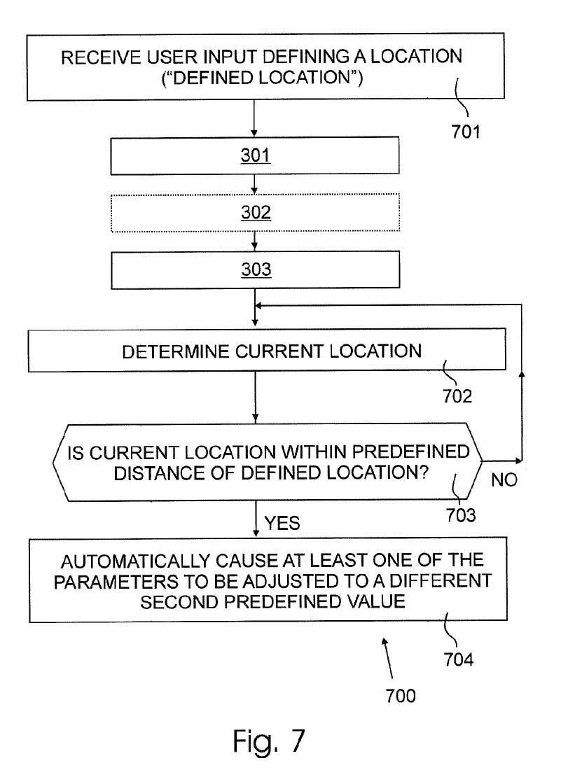

Another alternative method 700 of controlling an interior environment of a road vehicle is shown in the flow chart of FIG. 7. At block 701 a user input signal is received defining a location referred to below as the “defined location”. For example user interface may be provided at the user input device 104 (or 112) enabling a user input of a post code (or zip code), map reference, etc. The method 700 also comprises the blocks 301, 303 and optionally block 302, which may be the same as those blocks in method 300. After block 303, the current location of the vehicle is repeatedly determined at block 702 until it is determined at block 703 that the current location is approximately the same the defined location. That is, the current location of the vehicle is repeatedly determined at block 702 until it is determined that the current location is within a predefined distance of the defined location. For example, block 703 may determine whether the current location is less than one mile (1.6 km) from the defined location. The current location may be determined, for example, from data received from a GPS module, such as GPS module 202 of FIG. 2.

When it is determined at block 703 that the current location is within the predefined distance of the defined location, at least one of the parameters of block 303 is automatically caused to be adjusted to a second predefined value at block 704. For example, an air flow temperature and/or rate, and/or a lighting level may be increased. Thus, as described above, the second predefined value may be chosen to assist a sleeping passenger to awaken.

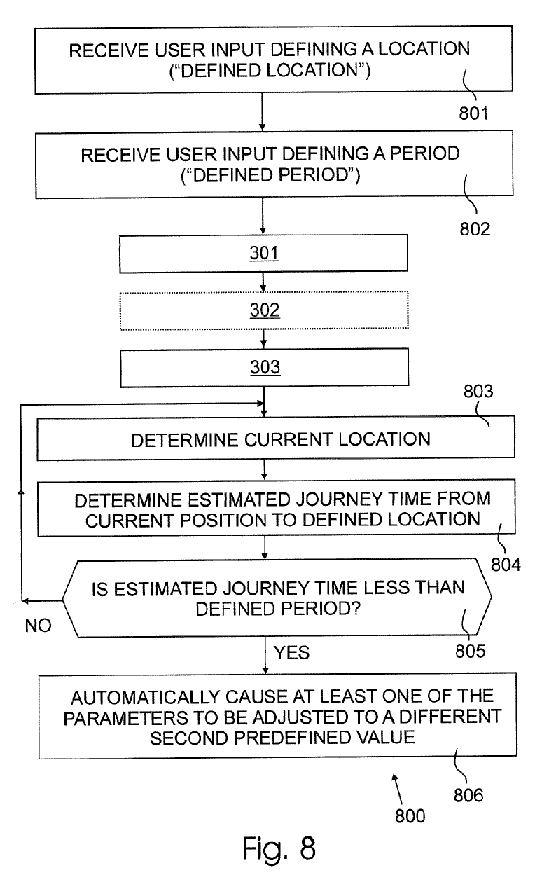

Another alternative method 800 of controlling an interior environment of a road vehicle is shown in the flow chart of FIG. 8. At block 801 a user input signal is received defining a location referred to below as the “defined location”. At block 802 a user input is received defining a period (referred to below as the “defined period”). The defined period may be selected by the user to arrange for assistance with waking up before the defined location is reached. The method 800 includes the blocks 301, 303 and optionally block 302 which may be the same as those blocks in method 300.

After block 303, the current location of the vehicle is determined at block 803, and at block 804 an estimated journey time from the current location to the defined location is determined. At block 805 it is determined whether the estimated remaining journey time is less than (or less than or equal to) the defined period. If it is not then blocks 803, 804 and 805 are repeated.

When, at block 805, it is determined that the estimated remaining journey time is less than (or less than or equal to) the defined period, at least one of the parameters of block 303 is automatically caused to be adjusted to a second predefined value at block 806.

Thus, by the method 800, a user is able to input their destination and a period of time, such as ten minutes, before they are expected to arrive, and the method automatically adjusts one or more parameters defining the interior environment of the vehicle to assist their waking before they reach their destination.

For purposes of this disclosure, it is to be understood that the controller(s) described herein can each comprise a controller or computational device having one or more electronic processors. A vehicle and/or a system thereof may comprise a single controller or electronic controller or alternatively different functions of the controller(s) may be embodied in, or hosted in, different controllers or controllers. A set of instructions could be provided which, when executed, cause said controller(s) or controller(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

As used here the word ‘module’ refers to a unit or an apparatus that provides one or more defined functions within the vehicle.

The blocks illustrated in the FIGS. 3 to 8 may represent steps in a method and/or sections of code in the computer program 115. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for controlling an interior environment of a road vehicle, the apparatus comprising:
a controller configured to control a seat adjustment mechanism means for adjusting a configuration of a passenger seat and control at least one parameter defining an interior environment of the road vehicle,
wherein the controller is configured to cause the seat adjustment mechanism to adjust the configuration of the passenger seat to a predefined configuration and cause a first one of the at least one parameter to be adjusted to a first predefined value, on receipt of a first signal from a user input device indicating a user selection of a first mode,
wherein the controller is configured to automatically cause the at least one parameter to be adjusted to a different predefined value following a prolonged period of time after causing the at least one parameter to be adjusted to the first predefined value, and
the prolonged period of time is ended in dependence upon a user-defined location, and received satellite navigation signals indicating a proximity to the location.

2. The apparatus according to claim 1, wherein the vehicle has a first row comprising a driver's seat, and wherein the passenger seat is located in a second row of the vehicle.

3. The apparatus according to claim 1,
wherein the controller is configured to control the seat adjustment mechanism to recline a backrest of the passenger seat to a predefined angle, to adjust a tilt of a seat cushion to a predefined angle, and/or to raise a calf rest on receipt of the first signal from the user input device.

4-5. (canceled)

6. The apparatus according to claims 1, wherein the apparatus comprises a plurality of interior environment modules, each of which is operable to adjust a parameter, and wherein the first one of the at least one parameter comprises a parameter of at least one of the plurality of interior environment modules.

7. The apparatus according to claim 6, wherein the interior environment modules comprise at least two modules selected from a group consisting of: a window blind module, a climate control module, an interior light module, a communications module, an audio module, an entertainment module.

8. The apparatus according to claims 1, wherein the at least one parameter defines a position of a window blind, and the controller is configured to cause the window blind to be moved to a closed position, on receipt of the first signal from the user input device.

9. The apparatus according to claim 1, wherein the at least one parameter comprises an air flow rate, and the controller is configured to control a climate control module to control a rate of flow of air into the interior of the vehicle to be adjusted to a first predefined value, on receipt of the first signal from the user input device.

10. The apparatus according to claim 1, wherein the at least one parameter comprises a temperature, and the controller is configured to control a climate control module to raise or lower the temperature of an airflow into the interior of the vehicle to at least a predefined temperature, on receipt of the first signal from the user input device, optionally wherein the predefined temperature is in the range 19 to 23 degrees centigrade.

11. (canceled)

12. The apparatus according to claims 1, wherein the at least one parameter defines a setting on a communications module, and the controller is configured to control the communications module to block or mute incoming phone calls, on receipt of the first signal from the user input device.

13. The apparatus according to claim 1, wherein the user input device enables the first mode to be selected in respect of individual passenger seats.

14. The apparatus according to claims 1, wherein the at least one parameter defines a setting of an interior light, and the controller is configured cause the interior light to be dimmed or switched off, on receipt of the first signal from the user input device.

15. (canceled)

16. The apparatus according to claims 1, wherein the user input device is configured to enable the first mode to be selected in respect of individual passenger seats, wherein the controller is configured to receive an input indicating seat occupancy, and, on receipt of the first signal from the user input device, the controller is configured to adjust at least one parameter defining an interior environment of the vehicle only in respect of the seat where the first mode is selected.

17. The apparatus according to claim 1, wherein the controller comprises a processor, the seat adjustment mechanism comprises an electric motor arranged to provide movement of a part of a seat, and the user input device is device configured to generate an electrical signal in response to receiving a physical input.

18. The apparatus according to claims 1, wherein the user input device comprises a user operable switch or a soft button on a touch sensitive display.

19. (canceled)

20. The apparatus according to claim 1, wherein the prolonged period of time is a user definable period.

21. (canceled)

22. The apparatus according to claim 1, wherein the controller is configured to receive satellite navigation data, to repeatedly determine whether the current location of the vehicle is within a predefined distance of a user-defined location, and to automatically cause the at least one parameter to be adjusted to a different predefined value in dependence upon a determination that a current location of the vehicle is within a predefined distance of the user-defined location.

23. The apparatus according to claim 1, wherein the controller is configured to receive satellite navigation data; to repeatedly determine an estimated journey time from a current location of the vehicle to the user-defined location, and to automatically cause the at least one parameter to be adjusted to a different predefined value in dependence upon a determination that the estimated journey time is less than a defined period of time.

24. A vehicle comprising the apparatus according to claim 1.

25. A method of controlling an interior environment of a road vehicle, the method comprising:
receiving a first signal indicative of a user input selecting a first mode; and,
in response to the first signal, controlling a seat adjustment mechanism to adjust the configuration of a passenger seat to a predefined configuration and causing at least one parameter defining an interior environment of a vehicle to be adjusted to a first predefined value: and
automatically causing the at least one parameter to be adjusted to a different predefined value following a prolonged period of time after causing the at least one parameter to be adjusted to the first predefined value, and
wherein the prolonged period of time is ended in dependence upon a user-defined location, and received satellite navigation signals indicating a proximity to the user-defined location.

26-28. (canceled)

29. A computer program product, comprising a non-transitory computer readable storage medium having encoded thereon instructions that, when executed on a processor, cause the processor to perform operations comprising:
receiving a first signal indicative of a user input selecting a first mode;
in response to the first signal, controlling a seat adjustment mechanism to adjust a configuration of a passenger seat to a predefined configuration and causing at least one parameter defining an interior environment of a vehicle to be adjusted to a first predefined value;
automatically causing the at least one parameter to be adjusted to a different predefined value following a prolonged period of time after causing the at least one parameter to be adjusted to the first predefined value, and
wherein the prolonged period of time is ended in dependence upon a user-defined location, and received satellite navigation signals indicating a proximity to the user-defined location.

30. (canceled)
